(19) United States
(12) Patent Application Publication
(10) Pub. No.: US 2009/0007559 A1
(43) Pub. Date: Jan. 8, 2009

(54) SERVO-CONTROL SYSTEM FOR HYDRAULIC UNIT FEEDING HYDRAULIC FLUID TO A VIBRATOR

(75) Inventor: Guillaume DAZIN, Champagne Sur Oise (FR)

Correspondence Address: BROWDY AND NEIMARK, P.L.L.C.;624 NINTH STREET, NW, SUITE 300, WASHINGTON, DC, 20001-5303, US

(73) Assignee: PTC, NOISY LE SEC (FR)

(21) Appl. No.: 12/167,805

(22) Filed: Jul. 3, 2008

(30) Foreign Application Priority Data
Jul. 3, 2007 (FR) 07 04783

(51) Int. Cl. F15B 9/14

(52) U.S. Cl. 60/445; 60/449

(57) ABSTRACT

The servo-control system for hydraulic unit according to the invention comprises a pump driven by a motor feeding hydraulic fluid to a vibrator or vibrating system comprising eccentric weights driven in rotation by at least one hydraulic motor receiving said fluid. It also comprises adaptation means for continuous adaptation of the rotation speed of the motor of the hydraulic unit in relation to the energy actually consumed by the vibrator.

### BACKGROUND OF THE INVENTION

1. Field of the Invention

The present invention concerns a servo-control system for a hydraulic unit feeding hydraulic fluid to a vibrator of the type used to ram objects such as piles, timber linings into the ground, or even a spindle-shaped vibrating system such as the type designated by the trademark “Vibrolance” for example, registered on behalf of the Applicant.

More precisely, “Vibrolance” is a spindle-shaped vibrator used for ground improvement methods, such as vibro-compaction or ballast filling. It comprises a counter-weight rotating at a speed in the order of 1500 to 3200 rpm, to obtain a force in the plane perpendicular to its axis of rotation.

2. Description of the Prior Art

Generally, for this type of application it is known that vibrators are frequently used which comprise one or more pairs of eccentric weights (counterweights) rotatably mounted inside a casing and rotating at the same speed but in opposite direction, so as to achieve a resultant consisting of a vertical force having sinusoid intensity (the horizontal components of the force cancelling each other out).

Usually, the eccentric weights are driven in rotation e.g. by hydraulic motors mounted on the casing, at speeds in the order of 1200 to 3000 rpm.

The generated amplitude of vibrations due to this rotation is related to the eccentric moment, to frequency (rotation speed) and to the total weight of the system (vibrator/mount/object to be rammed).

The moment of the vibrator can be fixed or variable. In this latter case, the vibrator comprises at least two sets of eccentric weights, each set comprising at least one pair of eccentric weights rotating in opposite direction, whilst the two sets of eccentric weights are coupled to each other via a phase shifter. By phase shifting the two sets it is possible to cause the amplitude of the oscillations to be varied between zero amplitude (out of phase) and maximum amplitude (in phase).

In all cases, the hydraulic motors receive hydraulic energy which they convert into mechanical rotation energy. A hydraulic unit supplies hydraulic energy to the vibrator motor via hydraulic hoses. This hydraulic unit comprises a motor (usually a heat engine) which drives a hydraulic pump in rotation.

The hydraulic power absorbed by the vibrator is very variable. It depends in particular on the depth of the insert of the object to be rammed, and on the geological characteristics of the ground concerned (soil type).

Usually the motor of the hydraulic unit is caused to operate at full speed to have a permanent power reserve. This gives rise to high fuel consumption, and to increased air and sound pollution.

### OBJECT OF THE INVENTION

It is the particular purpose of the invention to eliminate these drawbacks.

### SUMMARY OF THE INVENTION

It therefore proposes a servo-control system comprising means allowing continuous adaptation of the rotating speed of the hydraulic motor in relation to the energy actually consumed by the vibrator.

Advantageously, the hydraulic unit motor may comprise a device to measure its load rate, means being provided to ensure continuous adjustment of the motor's rotating speed in relation to the load rate.

Additionally, to offset the flow variations due to the variations in motor speed, a variable displacement pump can be used. The system can then comprise means to adjust the displacement of this pump continuously, so as to obtain the necessary flow rate (set rate).

### BRIEF DESCRIPTION OF THE DRAWINGS

One embodiment of the invention is described below with a non-limiting example with reference to the appended drawings in which:

FIG. 1 is a schematic illustration of a vibrator with its hydraulic fluid feed circuit, and its control/command circuit.

FIG. 2 is a block diagram of the dual servo-control system used in the control/command circuit illustrated FIG. 1.

### DESCRIPTION OF THE PREFERRED EMBODIMENTS

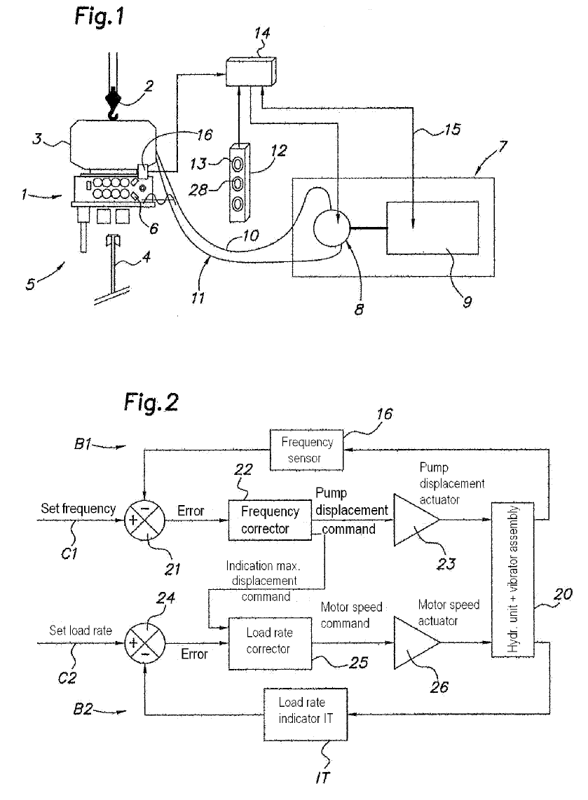

In the example illustrated FIG. 1, a vibrator 1 of conventional type is schematically shown, hanging from the hook 2 of lifting gear via a suspending mount 3. This vibrator is used to ram a timber lining 4. The connection between the casing of the vibrator 1 and the timber lining 4 is ensured via a hydraulic clamp 5.

The eccentric weights of the vibrator 1 are driven in rotation by at least one hydraulic motor 6 supplied with pressurized hydraulic fluid fed by a hydraulic unit 7 using a variable flow hydraulic pump 8 controled by an actuator enabling continuous adjustment of the displacement of pump 8, and a motor 9 driving the pump 8 in rotation. The connection between the pump 8 and the motor 6 of the vibrator 1 is obtained via two flexible conduits, namely a high pressure supply conduit 10 and a low pressure tank return conduit 11.

The motor 9 here consists of a heat engine equipped with a device to measure engine load rate (i.e. used power/available power ratio). It must also be equipped with servo-control of its rotating speed.

The control/command circuit associated with the vibrator 1 and with the hydraulic unit 7 uses:
a control box 12 (man/machine interface) comprising a button 13 (or similar) to adjust vibration frequency,
a central calculator 14 electrically connected to the heat engine 9 (two-directional link 15), to the hydraulic pump 8 (controling variation in displacement) and to a frequency sensor 16 mounted on the casing of the vibrator 1. The two-directional link 15 enables the calculator to control the rotation speed of the motor 9, and enables the motor 9 to send the calculator 14 information on its load rate.

A block diagram 20 of the hydraulic unit 7/vibrator assembly 1 is shown in the schematic FIG. 2.

This assembly is subjected to dual servo-control comprising:
A first servo-control loop B₁ comprising a subtractor 21 used to measure the difference between the frequency measured by the frequency sensor 16 and a set frequency C₁ displayed on the button 13. The difference signal (error) delivered by the subtractor 21 is transmitted to a frequency corrector 22 which produces a pump displacement control signal (flow rate) which is applied to the actuator 23 adjusting pump displacement (flow rate actuator).
A second servo-control loop B₂ comprising a subtractor 24 used to measure the difference between the instant value of the load rate of the motor 9, measured by a load rate indicator IT fitted to the motor 9, and a set load rate C₂. The difference signal (error) delivered by the subtractor 24 is transmitted to a load rate corrector 25 which produces a motor speed control signal which it applies to a motor speed actuator (power member 26). In this example, the load rate corrector 25 receives information on the maximum displacement control given by the frequency corrector 27.

The principle of the above-described servo-control system is therefore the following:
First, the operator defines a set vibration frequency, using the dedicated button 13 of the control box 12;
The vibration sensor 16 continuously measures the actual vibration frequency of the vibrator 1;
The calculator 14 compares the difference between the desired frequency (set frequency C₁) and the measured frequency given by the sensor 16, and accordingly controls correction of the flow rate of the pump 8 (by causing a variation of its displacement);
At the same time, the calculator 14 compares the measured load rate of the motor 9 with the set load rate C₂. The calculator 14 accordingly corrects the rotation speed of the heat engine 9. (If the measured load rate is lower than the set load rate C₂ and if the control for pump displacement is not at its maximum, the calculator 14 activates the slowing of the motor 9 e.g. by action on the throttle control. If the measured load rate is higher than the set load rate C₂, the calculator 14 activates the acceleration of the motor 9). The higher the set load rate C₂ (close to 100%), the better the savings on fuel. Conversely, a low set load rate C₂ will cause the motor 9 to operate at full speed. This set load rate C₂ may optionally be adjusted by the user using an adjustment member such as an adjustment button 28 on the casing 12. Nevertheless, this set load rate may be fixed and unable to be modified by the user.

To conclude, this solution consists of servo-controlling two actuators (pump flow rate and rotation speed of the heat engine) at the same time, for one same process in relation to two separate parameters (respectively the vibration frequency and the load rate of the heat engine).

When action is exerted on one of the servo-controls, the other must carry out compensation, since each one acts on one same process.

Evidently, the invention is not limited to the foregoing provisions. For example, the frequency sensor may be replaced by a hydraulic flow rate sensor positioned between the pump 8 and the vibrator 1: since vibration frequency is related to flow rate, the result is substantially the same.

Similarly, the sensor (frequency sensor 16 or for flow rate) may be omitted and replaced by means which perform a theoretical calculation of flow rate, based on control of pump displacement and of the rotation speed of the heat engine.

1. Servo-control system for a hydraulic unit comprising a pump driven
by a motor feeding hydraulic fluid to a vibrator or a vibrating system comprising eccentric weights driven in rotation by at least one hydraulic motor receiving said fluid,
comprising adaption means for continuous adaptation of the rotation speed of the motor of the hydraulic unit in relation to the energy actually consumed by the vibrator (1).

2. System according to claim 1,
wherein the hydraulic unit comprises a variable flow rate pump through variation of its displacement, and in that it comprises means to ensure continuous adjustment of the displacement of the pump so as to obtain a flow rate equal to a set flow rate.

3. System according to claim 1,
wherein the motor of the hydraulic unit comprises a device to measure its load rate, and said system further comprising means ensuring continuous adjustment of the motor's rotation speed in relation to said load rate.

4. System according to claim 1,
wherein the vibrator is provided with a vibration frequency sensor, the motor of the hydraulic group is a heat engine equipped with a device to measure its load rate, and the above said adaptation means include servo-control means comprising:
A first servo-control loop comprising a subtractor used to measure a first difference between the frequency measured by the frequency sensor and a set frequency value, and a frequency corrector which, in relation to said first difference, applies a flow rate control signal to the displacement adjustment means of the pump;
A second servo-control loop comprising a subtractor used to measure a second difference between the instant value of the load rate of the motor, measured by the said load rate measuring device, and a set load rate value, and a load rate corrector which, in relation to said second difference, applies a control signal to a motor speed actuator.

5. System according to claim 4,
wherein the load rate corrector receives a maximum displacement control signal from the frequency corrector.

6. System according to claim 4,
wherein said frequency sensor is replaced by a hydraulic flow rate sensor positioned between the pump and the vibrator.

7. System according to claim 4,
wherein the set load rate can be adjusted by the user.

8. System according to claim 4,
characterized in that the set load rate is fixed.

9. System according to claim 4,
wherein said said set frequency value can be adjusted by the user.

10. System according to claim 1,
wherein said vibrator has a fixed or variable moment.

11. System according to claim 1,
wherein said vibrating system is spindl-shaped.

12. System according to claim 5,
wherein if the measured load rate is lower than the set load rate and if the pump displacement control is not at its maximum, the servo-control means activate the slowing of the motor, and if the measured load rate is higher than the set load rate, the servo-control means activates the acceleration of the motor.

13. System according to claim 4,
wherein said frequency sensor is omitted and replaced by means performing a theoretical calculation of flow rate, based on control of displacement of the pump and of the rotation speed of the heat engine.
